(19) United States
(12) Patent Application Publication
(10) Pub. No.: US 2011/0036480 A1
(43) Pub. Date: Feb. 17, 2011

(54) METHOD OF JOINING FILMS

(75) Inventors: Martin Kropf, Muenchenbuchsee (CH); Christian Auchli, Steffisburg (CH)

Correspondence Address: COLLARD & ROE, P.C., 1077 NORTHERN BOULEVARD, ROSLYN, NY, 11576, US

(73) Assignee: ELAG VERPACKUNGEN AG, Kirchberg (CH)

(21) Appl. No.: 12/452,599

(22) PCT Filed: Jul. 11, 2007
(86) PCT No.: PCT/EP2007/006166

§ 371 Date: Apr. 5, 2010

(51) Int. Cl. B32B 37/04

(52) U.S. Cl. 156/73.4

(57) ABSTRACT

The invention describes a method of joining films made from at least one layer from the group comprising polyethylene, polypropylene polyamide and polyethylene terephthalate by welding. In order to produce the join, which is specifically required to withstand higher dynamic loads in terms of its strength, the materials are heated by ultrasound in the region of the contact layer as proposed by the invention until they have at least softened, and actively laterally and vertically intermixed by continuing to apply ultrasound.

The invention relates to a method of joining films made from at least one layer from the group comprising polyethylene, polypropylene polyamide and polyethylene terephthalate by welding.

A known way of manufacturing packaging made from plastic films is to weld the films to one another by applying heat. In this connection, it is preferable to use composite films comprising at least two layers and the layer facing away from the join has a higher softening temperature than the layer to be welded. In situations during production where several composite films are moved so that they lie one on top of the other, it may be desirable for the film composites not to be welded to one another. This is prevented by treating or coating the relevant surfaces. In technical terms, the relevant surface is the side of the composite film which is not sealable.

However, situations can occur in practice, for example when producing flat-end sacks, in which the composite films also have to be partially joined to one another at the non-sealable faces whilst imparting sufficient mechanical strength. The way this has been dealt with in the past is to partially cut away one of the composite films to be joined so that untreated or non-coated surfaces are moved one on top of the other in the relevant region. In connection with flat-end sacks, specialists in the industry refer to this as a “base corner hole”. However, these cut-outs cause undesirable weakening of the film join, which specifically has a negative effect when the joins are exposed to dynamic load. Another approach is to increase the applied heat and/or pressing force and/or sealing time, the aim being to enable layers to be joined which can not usually be joined to one another. However, this approach does not usually impart sufficient strength to the join.

Another known approach is to join plastic parts, including films, by means of ultrasonic welding. The region of the seam is heated due to the absorption of mechanical vibrations caused by the reflection of the vibrations in the seam zone and caused by superficial friction of the seam faces. Ultrasound welding has been used with success for thin and sealable films. The conventional ultrasonic welding method reaches its limits when it comes to joining films with a non-sealable layer and/or relatively thick films, however, because it is not possible to achieve a sufficiently well defined local energy density in the seam region.

Against the background of the prior art, the objective of the invention is to overcome the disadvantages outlined above and propose a method of joining films, enabling joins to be made which are capable of satisfying increased requirements in terms of resistance to dynamic load.

This objective is achieved by the invention due to the fact that the materials are heated by ultra-sound in the region of the contact layer so as to at least soften them and are actively laterally and vertically intermixed when ultrasonic vibrations continue to be applied.

The term “active” in this connection is intended to mean that intermixing of the materials also takes place due to external influences and not just due to heat and the effect of mono-directional pressure.

The advantage of this solution proposed by the invention is that brief homogeneous heating of the films enables the surfaces of the co-operating films to be actively intermixed, resulting in a high-strength join of the films capable of withstanding higher dynamic load. Another advantage of this method resides in the fact that even films with surfaces that are not intrinsically sealable can be joined. Yet another major advantage is that it is now possible to join even thick and relatively soft films to one another so that the join is also capable of withstanding increased dynamic loads.

In another embodiment, the depth of the zone of intermixing measures between 30% and 70% of the total thickness of the film seam. It has been found that this imparts maximum strength to the resultant join.

Based on another embodiment, at least one of the two films to be joined comprise two layers and the layer facing the join is made from polyethylene and the layer facing away from the join is made from polypropylene. Since polyethylene has a lower softening temperature than polypropylene, heat may be applied at a temperature between these two softening temperatures so that the join is produced in the region of the contact layer.

Also of advantage is another embodiment whereby at least one of the films to be joined comprises two layers, and the layer facing the join is made from polypropylene and the layer facing away from the join is made from polyamide or polyethylene terephthalate. A structure of this type is beneficial due to the differing softening temperatures of both conventional thermal seals and those obtained by the method proposed by the invention.

Also of advantage is another embodiment where at least one of the films to be joined comprises more than two layers. This feature broadens the range of applications for which products made by the method proposed by the invention may be used.

In the case of another embodiment, a surface is treated or coated with a view to reducing sealability, for example by corona discharge or lacquering. The desired reduction in sealability in this instance is intended to prevent the film surface from undesirably sticking to dies and machinery parts but does not prevent a high-strength join from being obtained due to the piercing in the relevant layer achieved by the method.

Also of advantage is another embodiment whereby ultrasound is homogeneously applied by an essentially flat surface of a sonotrode across the cross-section of the film seam. This enables the use of simple and hence inexpensive sonotrodes.

If, as is the case with another embodiment of the method, the working surface which comes into contact with the film vibrates predominantly in a direction perpendicular to its surface, the amount of energy which can be introduced is particularly beneficial.

In the case of another embodiment, a co-operating die with at least one raised area is disposed on the side of the join lying opposite the sonotrode, which is pushed into the previously softened film material. This feature assists and enhances the lateral and vertical inter mixing of the plastic film material.

In another embodiment, the at least one raised area is elongate. As a result, the shape and dimensions of the resultant joins can be adapted to a range of different requirements.

Also of advantage is an embodiment where the at least one raised area has a cross-section in the shape of a trapezium or trapezoid. This is particularly conducive to lateral intermixing of the plastic film material. In this respect, the base angles are advantageously in a range of between 20° and 90°.

In one advantageous embodiment, the at least one raised area has interruptions distributed across its length. This feature leads to a more effective distribution of the plastic film material.

Also of advantage is an embodiment in which the film facing the co-operating die comprises at least two layers and the height of the at least one raised area is higher than the thickness of the layer facing the co-operating die. This ensures that the interfacial layers of the films to be joined are reliably pierced.

In another embodiment, the co-operating die has means in order to cool it. Without cooling, the die becomes hot due to the heat transmitted from the film, which can lead to undesirable melting of the film surface facing the co-operating die.

In one embodiment in which the films or their layers facing the join have a thickness in a range of from 15 μm to 1 mm, products can be obtained which satisfy the high requirement for strength, in particular as regards dynamic loads.

Also of advantage is another embodiment in which the join is pressed and cooled in order to promote hardening. Cooling leads to faster solidification of the resultant join and pressing reduces the height of buckled areas which occur in the film surface during piercing by the raised areas of the co-operating die.

In the case of yet another embodiment, the films are fed through a production plant from at least one roll in the form of a material web. This enables articles such as bags to be produced inexpensively on a mass basis.

In the case of another embodiment, thermal welds and/or deformations are made in certain regions of the films before or after processing with ultrasound. This enables the overall cost of producing articles to be optimised because there is no need to use relatively expensive ultrasonic dies for all seals.

Finally, in the case of another embodiment, means are provided in the production line for temporarily releasing the tension imparted to the material web as it is fed. This prevents any undesirable relative shifting of the joined films prior to hardening the join.

A more detailed description of examples of embodiments will now be given with reference to the appended drawings. Of these

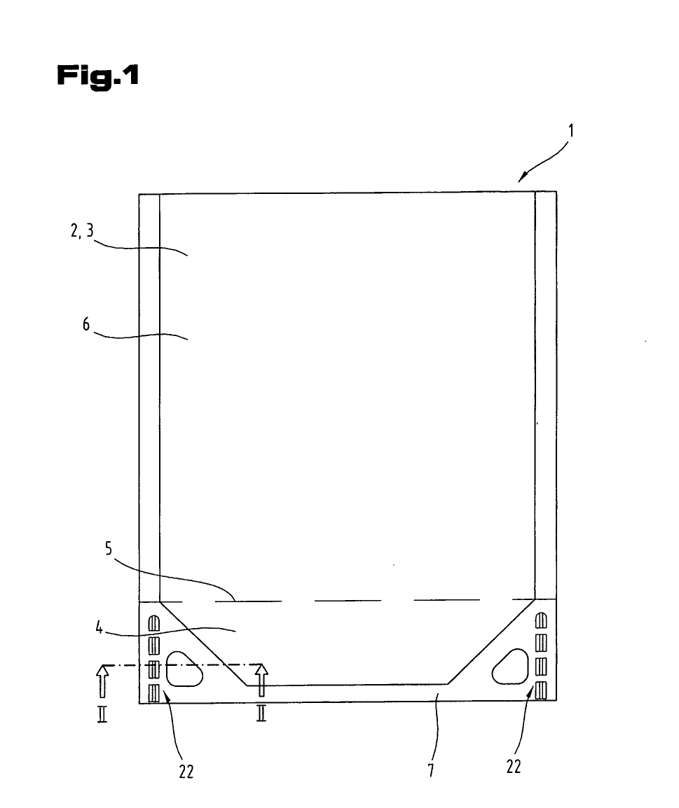

FIG. 1 is a plan view of a flat-end sack with plastic films partially joined to one another by the method proposed by the invention;

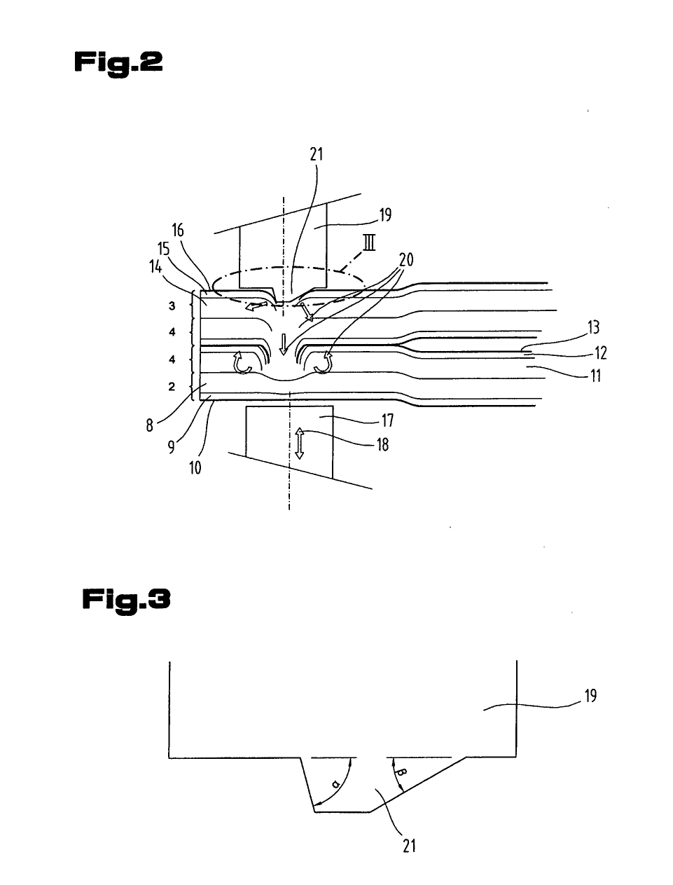

FIG. 2 is a cross-section through the joining point along line II-II indicated in FIG. 1;

FIG. 3 shows detail III from FIG. 2 on a larger scale.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIG. 1 is a plan view showing a flat-end sack 1 of a known type in the flat, non-filled state. The flat-end sack 1 comprises a front face film 2 and a rear face film 3, which are welded to one another at their left-hand and right-hand side edge by seal edges 6. Inserted in the bottom region of the sack between the front face film 2 and the rear face film 3 is a base film 4 which is folded along a fold line. A leg of the base film 4 is joined by a base seal edge 7 to the front face film 2 and the rear face film 3 respectively.

In order to ensure that the sack will stand upright more reliably, the front face film 2 and the rear face film 3 are joined to one another in the bottom corner region of the sack 1. Experience has shown that this area is exposed to high mechanical stress if the sack is dropped in the filled state. This join is therefore made by deep seals 22 using the method proposed by the invention.

FIG. 2 shows a cross-section through the joining point along line II-II indicated in FIG. 1. As may be seen, it extends through each of the co-operating films in this example, namely the front wall film 2, the base film 4 and the rear wall film 3, each comprising two layers, namely a sealable layer 8, 11, 14 and a non-sealable layer 9, 12, 15. The sealable layer 8, 11, 14 is made from polyethylene, for example, and has a thickness of 200 μm. The non-sealable layer 9, 12, 15 is made from polypropylene, for example, and has a thickness of 20 μm.

In order to improve the compressibility of the film but also with a view to preventing the film from sticking to the sealing dies, the externally lying surface of the non-sealable layer 9, 12, 15 can be treated in each case, in particular roughened or coated. Roughening can be achieved, by etching or by a corona treatment. The roughening or coating in FIG. 2 is indicated by references 10, 13, 16.

In the example illustrated, two non-sealable layers 12 which are also provided with a coating 13 meet in the middle of the film seam, and this is known to cause problems when joining the films. These problems mean that the join, if one can be obtained at all, is not very strong and therefore breaks when exposed to only a slight amount of mechanical stress.

As clearly illustrated in the diagram of FIG. 2, the problem of this inadequate join described above is eliminated by the method proposed by the invention. Ultrasonic vibrations are transmitted into the films to be joined by means of a sonotrode 17, which causes the material of all the layers to heat up and soften. The vibrating movement of the sonotrode is indicated by double arrow 18. A co-operating die 19 with raised areas 21 is provided, which penetrates the softened films and causes an active lateral and vertical intermixing of the materials in the region of the contact surface, as indicated by arrows 20.

FIG. 3 illustrates the detail denoted by “III” in FIG. 2 but on a larger scale. The raised areas 21 are preferably of a trapezium-shaped or trapezoid-shaped cross-section in order to produce optimum displacement and intermixing of the film material to which the ultrasonic vibrations are transmitted. As may be seen from the visible indentations made by the raised areas 21 in FIG. 1, the raised areas 1 have interruptions along their longitudinal extension. The contour of the intermixed and welded material thus assumes the form of an essentially waved line, which further improves the strength of the join.

If mass producing sacks of the type described above using the method proposed by the invention, for example, a ready printed film comprising a thicker polyethylene layer and a thinner polypropylene layer will be delivered on rolls. To make printing easier, the polypropylene layer is roughened by means of a corona treatment, for example. The film web unwound from the roll is cut down the centre of the length and the resultant web halves are turned and fed one above the other with a base film web folded lengthways in between. As the webs move synchronously in a timed cycle, the side seal edges 6 and the base seal edges 7 are produced in steps by thermal dies. At a station equipped with the sonotrode 17 and the co-operating die 19, two deep seals 22 (FIG. 1) are formed using the method proposed by the invention, and the sonotrode 17 and co-operating die 19 are designed so that two deep seals 22 are produced on an two sacks created one after the other in the webs. In this connection, it has been found that the tension which exists in the webs can have an adverse effect on the quality of the deep seals 22. Although a certain amount of tension is necessary in order to transport the webs and keep them taut on the production line, this tension can lead to undesirable shifting when working with elastic materials, as is the case here. It is therefore preferable to secure the corresponding portion of the webs when creating the deep seal 22 and at least partially relieve them of tension. The co-operating die 19 is preferably provided with cooling passages through which a coolant circulates, for example. The energy transmitted by the sonotrode 17, which causes a plastic stage to occur in the interior of the film composite, will depend on the material and the thickness of the film used. For a film thickness of 0.8 mm, the period during which the ultrasound is active will be within a range of from 0.2 s to 2 s. It goes without saying that the sonotrode may be actively cooled. Due to their good heat conductivity, sonotrodes made from aluminium are particularly suitable for this purpose. To prevent the film surfaces from being damaged as far as possible, the ultrasonic output is increased whilst the deep seal 22 is being produced and the run-up time will be between 0.1 s and 1 s. The phases of applying ultrasonic energy and punching the raised areas 21 into the films overlap and when the ultrasonic energy is switched off, a holding phase is run during which the sonotrode 17 and co-operating die 19 remain in a closed position. The holding phase for a film thickness of 0.8 mm lasts 0.2 s to 2 s.

After the process of producing the deep seal 22, a pressing device with cooled pressing jaws is provided in the production line, by means of which the deep seals 22 are pressed flat and cooled. Any film material which buckled as the raised areas 21 were punched in is pressed flat again. Finally, the sacks are cut from the web, checked and prepared for despatch or filling with a product.

The embodiments illustrated as examples represent possible variants of a packaging sack made using the method proposed by the invention and it should be pointed out at this stage that the invention is not specifically limited to the variants specifically illustrated, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

For the sake of good order, finally, it should be pointed out that, in order to provide a clearer understanding of the structure of the packaging sack and the welded join, they and their constituent parts are illustrated to a certain extent out of scale and/or on an enlarged scale and/or on a reduced scale.

### LIST OF REFERENCE NUMBERS

1 Flat-end sack
2 Front face film
3 Rear face film
4 Base film
5 Fold line
6 Lateral seal edges
7 Base seal edges
8 Sealable layer
9 Non-sealable layer
10 Coating
11 Sealable layer
12 Non-sealable layer
13 Coating
14 Sealable layer
15 Non-sealable layer
16 Coating
17 Sonotrode
18 Vibrations
19 co-operating die
20 Arrows (mixing)
21 Raised areas
22 Depth seals

1. Method of joining films made from at least one layer from the group comprising polyethylene, polypropylene polyamide and polyethylene terephthalate by welding, wherein the materials in the region of the contact layer are heated by ultrasound until they have at least softened and are actively laterally and vertically intermixed by continuing to apply ultrasonic vibrations.

2. Method as claimed in claim 1, wherein the depth of the intermixing zone measures between 30% and 70% of the total thickness of the film seam.

3. Method as claimed in claim 1, wherein at least one of the films to be joined comprises two layers, the layer facing the join being made from polyethylene and the layer facing away from the join being made from polypropylene.

4. Method as claimed in claim 1, wherein at least one of the films to be joined comprises two layers, the layer facing the join being made from polypropylene and the layer facing away from the join being made from polyamide or polyethylene terephthalate.

5. Method as claimed in claim 1, wherein at least one of the films to be joined is made from more than two layers.

6. Method as claimed in claim 1, wherein one surface is treated or coated with a view to reducing sealing ability, for example by a corona treatment or lacquering.

7. Method as claimed in claim 1, wherein ultrasound is homogeneously transmitted to the cross-section of the film seam via an essentially flat surface of a sonotrode.

8. Method as claimed in claim 1, wherein the working surface of the sonotrode which comes into contact with the film vibrates predominantly in a direction perpendicular to its surface.

9. Method as claimed in claim 7, wherein a co-operating die with at least one raised area is disposed on the side of the sonotrode lying opposite the join, which is pushed into the previously softened film material.

10. Method as claimed in claim 9, wherein the at least one raised area is elongate.

11. Method as claimed in claim 8, wherein the at least one raised area has a cross-section in the shape of a trapezium or trapezoid.

12. Method as claimed in claim 11, wherein the base angle of the at least one raised area lies within a range of between 20° and 90°.

13. Method as claimed in claim 9, wherein the at least one raised area has interruptions distributed across its length.

14. Method as claimed in claim 8, wherein the film facing the co-operating die comprises at least two layers and the height of the at least one raised area is higher than the thickness of the layer facing the co-operating die.

15. Method as claimed in claim 9, wherein the co-operating die is provided with means for cooling it.

16. Method as claimed in claim 1, wherein the films or their layers facing the join have a thickness in a range of from 15 mm to 1 mm.

17. Method as claimed in claim 1, wherein the join is pressed and cooled to promote hardening.

18. Method as claimed in claim 1, wherein the films are fed through a production line from at least one roll in the form of a material web.

19. Method as claimed in claim 18, wherein thermal welds and/or deformations are made in regions of the films before or after processing with ultrasound.

20. Method as claimed in claim 18, wherein means are provided on the production line for temporarily relieving the tension introduced into the material web as it is transported.
